(19) United States
(12) Patent Application Publication
(10) Pub. No.: US 2006/0007426 A1
(43) Pub. Date: Jan. 12, 2006

(54) Novel Algorithm, Method and apparatus for In-Service Testing of Passive Optical Networks (PON) and Fiber to the Premise (FTTP) Networks

(76) Inventor: Whitney Turrel Weller, Exeter, NH (US)

Correspondence Address: WHITNEY TURREL WELLER, 4 TAMARIND LANE, EXETER, NH, 03833, US

(21) Appl. No.: 10/710,410

(22) Filed: Jul. 8, 2004

(51) Int. Cl. G01N 21/00

(52) U.S. Cl. 356/73.1

(57) ABSTRACT

Locating a fault of an optical transmission line in a system which performs bidirectional optical communication between a wire center Optical Line Terminal (OLT) and plural subscriber devices, Optical Network Terminal (ONT). In this ITU defined topology, a feeder extending from the OLT is branched by a passive (non powered) splitter/coupler device into plural legs each connected to the ONT devices. The present invention encompasses a novel test apparatus and technique for fault location on Passive Optical Networks (PON) and/or Fiber of the premise Networks (FTTP), encompassing APON, BPON and EPON allowing non-service interruptive test, without damage to the ONT or OLT transceivers. The invention provides service providers the ability to locate a fault occurring on an optical transmission line while the system is actively performing bidirectional optical communication between a OLT/head-end device and plurality of ONT/subscriber devices.

### CROSS REFERENCE TO RELATED APPLICATIONS

U.S. Pat. No 5,187,362 February, 1993 Keeble 250/227. U.S. Pat. No. 6,028,661 February 2000 Minami et al. 356/73. Foreign Patent Documents 9-152386 June 1997 JP. 9-329526 December, 1997 JP. 10-239539 September, 1998 JP. USPTO Disclosure Document No. 550769 Apr. 6, 2004

### BACKGROUND OF INVENTION

The present invention is an enhancement to current methods for testing the feeder and respective transmission legs using currently available methods. The Optical TestNode (OTN) is a novel apparatus which incorporates a novel FTTP Test Algorithm, the OTN emits an optical test signal, observes a reflected signal. The test signal, whose optical frequency is chosen using the novel FTTP Test Algorithm, results in the test signal operating in an optical band that is not normally used for in-service data transmission or testing, and is contained within the optical spectrum of the ITU G.983 architecture. As a result of this novel choice of frequency the present invention has the ability to locate faults without damage to sensitive transceiver equipment. Physical fiber condition can be sensed based on a return time and a return loss of the reflected test signal. Thus the present invention encompasses a novel method of characterizing, fault identification, test and analysis for Fiber to the Premise (FTTP), Optical Distribution Networks (ODN) as described in ITU G983. The ODN is designed to support Voice, Data and Video services. It is the Frequency Division Multiplex nature of band separation which allows the present invention to provide benefits over existing methods of test.

Such networks provide a Wave Division Multiplex (WDM) bidirectional single fiber feeder (transmission line 1) extending, but not limited to, 20 Km-40 Km from the Optical Line Terminal (OLT) toward the Optical Network Terminal (ONT). At the end of the 20 Km-40 Km feeder section the fiber terminates on a multi-port optical splitter/coupler. The multi-port splitter/coupler divides the bi-directional optical traffic into N different legs. The N different legs traverse the final multiple kilometer distance between the splitter/coupler and the subscriber location where the legs are individually terminated at the Optical Network Terminal (ONT) located at the subscriber premise.

There are several challenges when one attempts to test this type of physical transport topology.

(a) The first challenge, addressed by the present invention involves optically coupling an OTDR to the fiber feeder using conventional optical switching and WDM band pass filter technology. (prior art)

b) The second challenge, solved by the present invention, is obtaining optical test spectrum on the ODN without causing disruption of service to those customers sharing the infrastructure. The present invention addresses this issue in a way no other method has in the past. This novel approach requires one to follow the novel Test Algorithm of the present invention, to select the appropriate “algorithm defined” optical frequency band for tuning the OTDR and the access WDM filters used when testing the ODN. The said tests may then be carried out without disruption of service for the ODN equipped with fully functional OLT and ONT devices.

c) The third challenge, addressed by present invention is fault location and identification in the presence of excessive loss characteristics of the ODN when equipped with tandem splitter/couplers or where N>8. In the description of the preferred embodiment, we will use N=32 as a case in point. Typically the insertion loss is the identified and selected as a matter of ODN design. Single direction insertion loss for the splitter/coupler becomes the dominant design parameter and results in limitations to the range of lengths for the combination of the feeder and the legs for the resultant ODN.

(d) The fourth issue, addressed by the present invention includes a novel application of customized software which correlates the reflected response from the ODN to the test pulse transmitted from the OLT end of the feeder, branched through the splitter, reflected by impairments or optical discontinuities and recombined by the splitter/coupler onto the feeder.

The return signals represent a plurality of legs, the impairments thereon and the presence of ONT electronics atthe ends of the legs. In the preferred embodiment of the invention a Optical Time Domain Reflectometer (OTDR) is tuned to the specific optical frequency designated by the present invention. Test pulses, generated at the specified frequency will propagate through an optical fiber, connector, splitter or other passive components having known and quantifiable insertion loss values. The optical reflection profile of any set of components and fiber transmission lines will yield a unique OTDR signal signature.

In the preferred embodiment this signature is evaluated through the use of test pulses at the preferred frequency, which is determined by the present invention to be specifically directed to a portion of the optical band. A portion of the band where the OLT and ONT equipment will be least sensitive to the test signal. At this specific frequency the reflections from the ONT will be either large or highly attenuated depending on the OLT and ONT design and manufactures component choices. The present invention provides a solution which allows testing benefits in either case from the attenuation characteristics of the OLT and OLT component selection. The specific wavelength identified by the novel FTTP Test Algorithm and implemented as part of the preferred embodiment of the present invention is selected such that it does not interfere with routine traffic on the network. As such, the ODN may be tested at any time without impact to normal operation of the network or disruption of customer service.

As an example, when an “algorithm defined” test pulse is applied from the OTN optical access point near the OLT by an OTDR and the OTDR is tuned according to the FTTP Test algorithm, testing may proceed without interruption of service to the traffic on the ODN. In the preferred embodiment of the present invention baseline measurements are done at the time of optical fiber installation. From the baseline test data a topology record is recorded that shows the exact length of feeder, the loss through the splitter and the loss through the legs which connect to the premise. The exact position and optical characterization of the components contained in ONT 1 through ONT N are recorded. Also noted are any unique irregularities for each feeder group. Measurements are also made of the ores the baseline signature of the network after optical network. The data recorded as baseline may be recalled by the system such that subsequent testing identifies changes in the network since the baseline measurement. These changes may include but are not limited to fiber breaks, micro bending and connector termination or splitter degradation.

The concept of testing at the “algorithm defined” wavelength may be applied to many banded optical transmission WDM systems. In all cases, the use of an “algorithm defined” wavelength to provide continuous monitoring is a generalization of the approach described herein of the in-service operation. The present invention uses an algorithm that chooses an “algorithm defined” optical test wavelength or wavelengths located at the maximum attenuation point of the band-splitting filters because these frequencies are non-disruptive to the OLT and ONT equipment attached to the end of the fiber network. Typical fiber to the premise applications employ several pass bands for the transmission of signals to and from the subscriber. In the preferred embodiment, but not limited to that which is represented by the standard the G.983 approach the following optical frequency ranges have been assigned.

Downstream traffic for voice and data occupy the 1490 nm band, downstream traffic for video occupy the 1550 nm band and upstream voice and data occupy the 1310 nm band. Given the optical bands must be filtered in and out to prevent cross talk between bands at the transceiver present in the OLT and ONT. Applying the novel FTTP Test Algorithm for selection of a non-disruptive optical test frequency as part of the present invention, one would choose the center point for the separation filter for the incoming optical bands. Many applications will require to use a test wavelength in the range of 1490-1550 nm. The choice of the wavelength in this embodiment defines the desired wavelength at 1520 nm and, given a Gaussian filter profile will result in the maximum attenuation or filter rejection by the OLT and ONT terminating component. The wavelength selected in this embodiment is “algorithm defined” from the operating wavelengths of vendors OLT and ONT equipment. The algorithm selects a wavelength within the transmission pass band for the fiber plant and in the optical rejection portion of the band filter for the components present on the working line. Use of the present invention allows for in-service testing outside of the transmission pass band the OLT and ONT.

Once a baseline signature has been recorded for the network, in the preferred embodiment of the system that-would use the present invention, a novel application of custom software tracks changes from the baseline test through periodic maintenance testing for comparison. The process may be completed without network interruption or physical disruption. Both physical, environmental and catastrophic changes due to weather, aging and other considerations may be monitored with the customer in-service. If the signature deviates from expected limits the administrator is notified with information as to the precise location and nature of the fault or event.

### SUMMARY OF INVENTION

This disclosure document outlines a unique and novel application of a custom means for characterization, testing and analysis of test results. The method disclosed hereuses a Optical Time Domain Reflectometer tuned to an “algorithm defined” wavelength. The system retains the baseline measurements for feeder networks or has the baseline measurements downloaded from a service provider support system. The Optical Test Node (OTN) and compares current results with historical results. This novel invention tests the Optical Distribution Network ODN at a wavelength that is unique. This method employs the current practice of basic concept of reflection delay of a test signal propagated through a fiber, or set of fibers. The current technology uses a broad spectrum pulses and wavelengths from 450 nm to 1650 nm sweep to generate a return loss profile of a fiber under test. The current test solutions can only be used when the network is out of service or pieces of the network fiber feeders and legs are physically disconnected from the network. The novel approach contained herein allows testing of feeder and branch networks. (described by ITU G983.1) Current techniques are unable to observe and resolve multiple reflections and locate impairments on the optical line under test. The novel characteristics of the present invention allow testing of the FTTP topology without damage to the sensitive transmission terminal equipment, is solved by the correct selection of a test frequency for the OTDR by the novel FTTP Test Algorithm contained herein. The combination of the ability to test in the presence of live traffic and the use of custom software for the resolution and autocorrelation of incoming reflective echoes with historical data comprises a novel and unique solution for testing and fault location of optical impairments on an ODN.

Optical Time Domain Reflectometry—Optical fibers may be evaluated by examining the reflection of a test pulse applied at a convenient WDM insertion filter point. A test pulse is applied of sufficient power, amplitude, width and duty cycle to allow for propagation through the desired length of optical fiber. At the location of an the optical splitter/coupler the signal is divided into “n” legs such that the power on each leg is attenuated based on the specifications (/characteristics) of the Splitter/Coupler. Reflections caused by impairments or discontinuities are analyzed by monitoring the time of flight from pulse launch and return intermittently between the transmission of test pulses. Analysis of the resultant reflected pulse time delay, reflected pulse amplitude and other characteristics of the reflection can be correlated and analyzed to form a map allowing. One can therefore assessment of the condition, location of fiber breaks, micro-bends and termination of the fiber under test. This “transmit and listen” method is often referred to as Optical Time Domain Reflectometry (OTDR).

Propagation Delays in Optical Fibers—The delay in time between launch of test pulses and the return of energy, reflected from fiber anomalies, at the insertion point (time of flight) is directly related to the length of fiber traveled by the pulse. The exact location of abnormalities on the fiber run such as breaks, kinks or terminations. This direct correlation between time delay and location of elements along the fiber run allows for precise testing of fiber networks through the use of OTDR technologies.

Significance of reflections—The nature of optical components gives rise to the fact that light energy tends to be reflected to some extent from components such as connectors, splitters or other components and either transmitted through or absorbed by components such as optical fiber. Connectors, splitters and detectors may be accurately characterized for an acceptable level of reflection. Similarly, optical fiber, splices and other components may be accurately characterized for acceptable levels of signal loss and inherent reflection. These component characteristics may be assembled to from a network signature of expected loss and optical reflection. An example of an OTDR signature is shown for a simple network in FIG. 1.

### BRIEF DESCRIPTION OF DRAWINGS

FIG. 1 Typical ITU G983 Optical Distribution Network(ODN) Example for Which the Present Invention Tests While Transmission is In-Service Without Causing Damage to The Optical Transceivers. This illustrates the network topology which was heretofore not testable while transmission was in-service and not possible without damaging the sensitive transceiver components attached at each end of the ODN.

FIG. 2 Optical Transmission Line (Prior Art) Shown to Illustrate The Present Inventions Novel FTTP Test Algorithm Which Will not Damage OLT, ONT and Video Transceivers. This figure illustrates the elements of a preferred embodiment of an FTTP transmission system. The apparatus for testing the FTTP transmission is displayed in this illustration for purposes of discussion.

FIG. 3—Application of The Preferred Embodiment of the Novel FTTP Test Algorithm of the Present Invention for Optical Test Interrogation of OLT, ONT and Video transceivers. This illustration provides a detailed functional view of the internal workings of a typical multioptical transceiver.

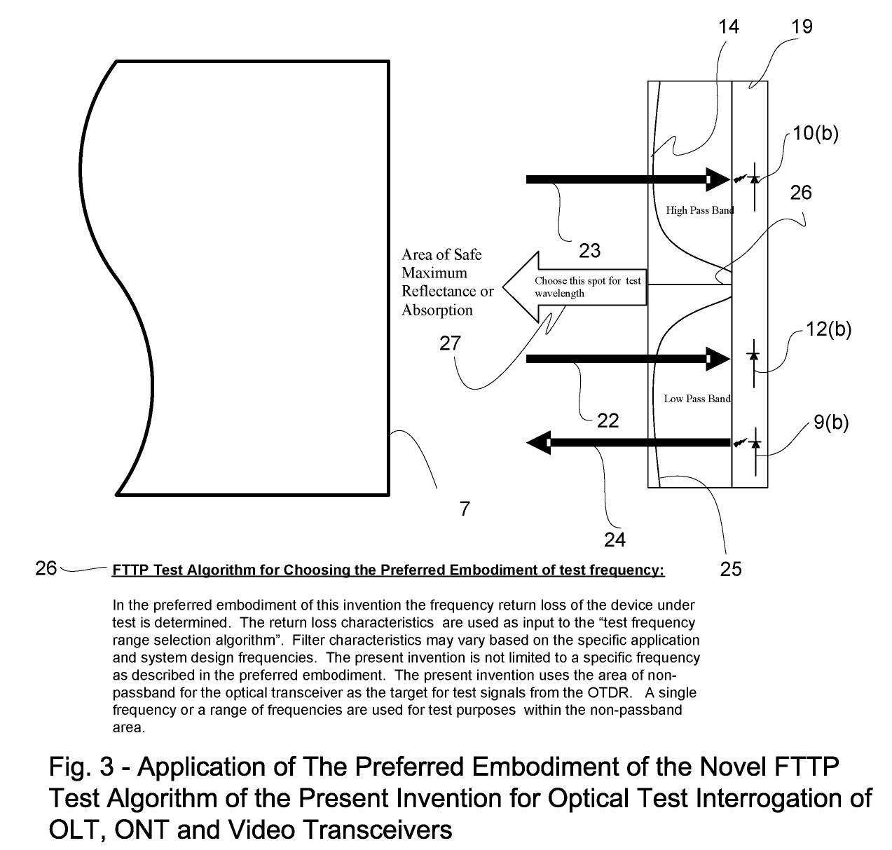

FIG. 4—Step by Step Method to Use of The Novel FTTP Test Algorithm in the Preferred Embodiment of the Present Invention. This illustration shows an example, but is not limited to, the steps illustrating the application of the FTTP Test Algorithm and apparatus to finding optical faults and impairments on a typical FTTP ODN.

FIG. 5—Preferred Embodiment of the Present Invention—Optical Test Node (OTN) Operational Sequence illustration provides details on the operational test sequence performed by the Optical Test Node.

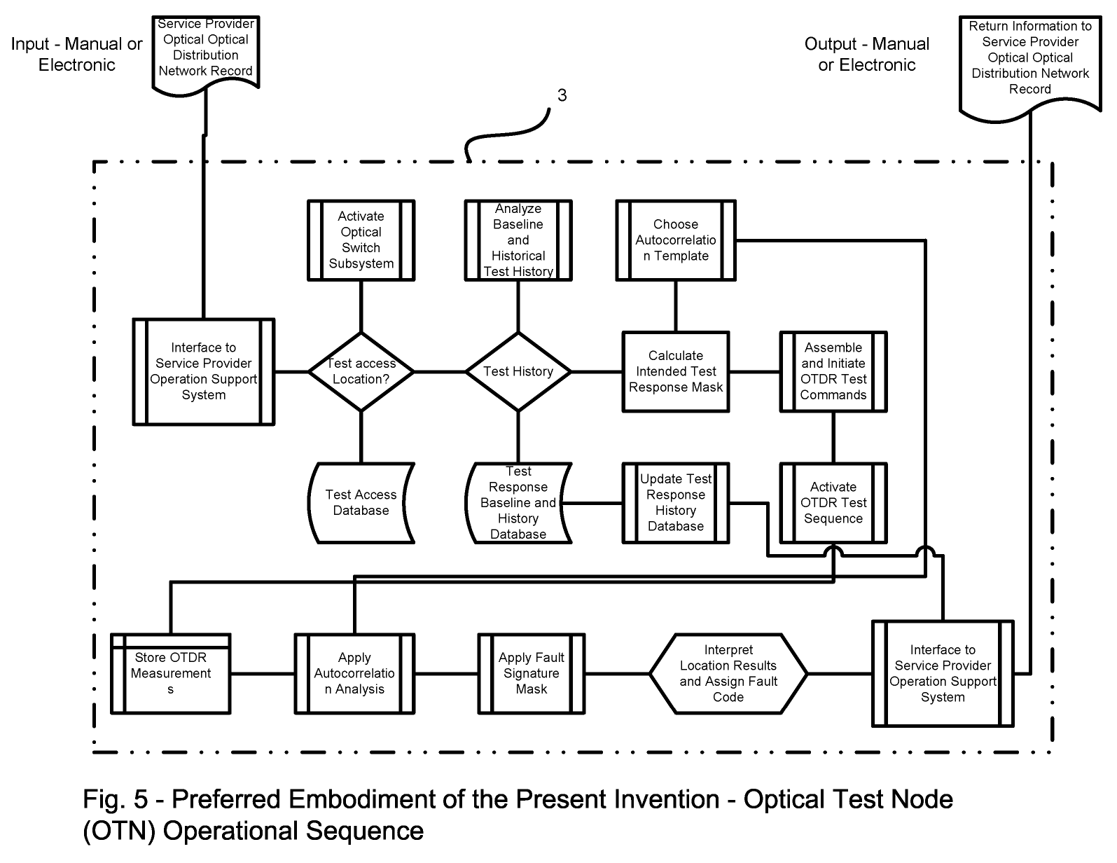

FIG. 6—Preferred Embodiment of the Present Invention—Optical Test Node (OTN) Apparatus—This diagram describes the Optical Test Node.

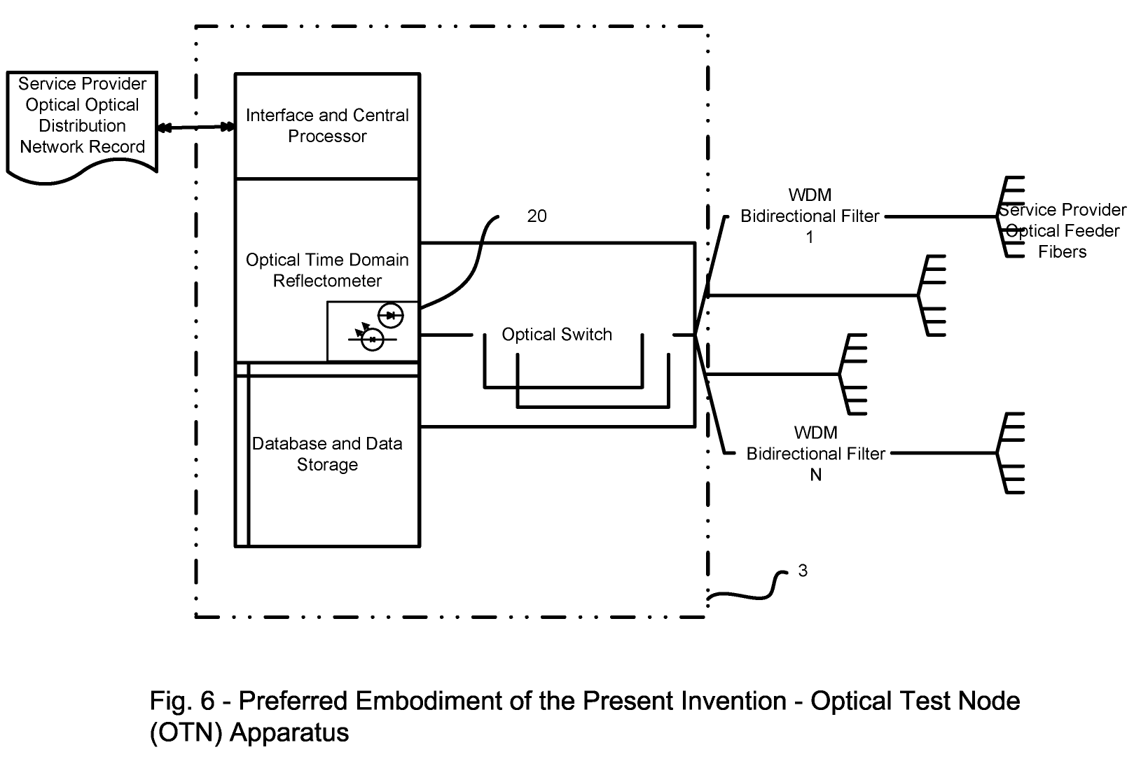

### DETAILED DESCRIPTION

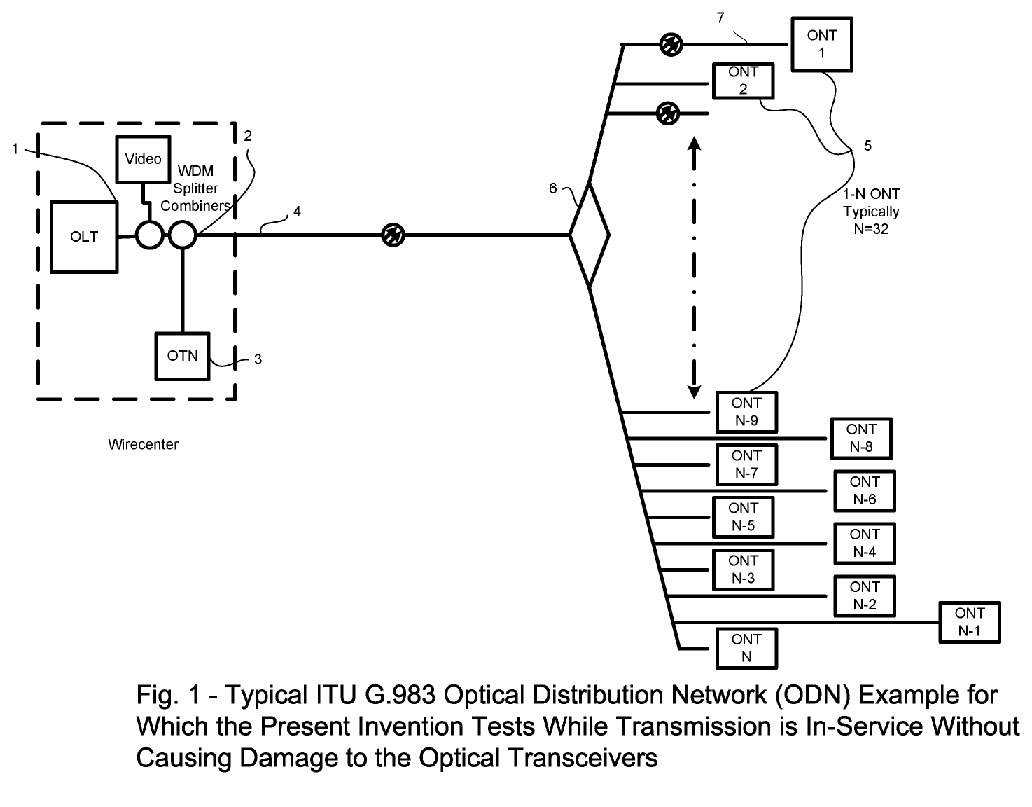

In the preferred embodiment of this invention the frequency return loss of the device under test is determined. The return loss characteristics are used as input to the “test frequency range selection algorithm”. Filter characteristics may vary based on the specific application and system design frequencies. The present invention is not limited to a specific frequency as described in the preferred embodiment. The present invention uses the area of non-pass band for the optical transceiver as the target for test signals from the OTDR contained in the Optical Test Node (OTN) (3). A single frequency or a range of frequencies are used for test purposes within the non-pass band area or rejection area (26) of the optical triplexer (8(a), 8(b)). Every effort has been made to use terminology that is consistent with ITU G.983 standards for PON architecture, in which a feeder (transmission line 1) (4) is defined as extending from the Optical Line Terminal OLT(1) to the Optical Network Terminal ONT (5). The feeder (4) is branched by a branching/coupling device (6) into N transmission lines where N represents the number of branched legs (transmission line 2). The number N legs chosen by the transmission engineer based on the optical loss budget of the Optical Distribution Network (ODN) as shown in FIG. 1. Each leg being connected to one of ONT and capable of bidirectional transmission. The present invention provides a novel and proprietary method to locate faults on the feeder (transmission line 1) (4) and/or the legs (transmission line 2) (7) without damage to the sensitive optical transceivers of the OLT (1) or the ONT(5). Using the method of the present invention, choice of wavelength (26) allows test signals used to stimulate the optical transmission line (4,7) to measure impairments on the optical transmission line without causing damage to sensitive terminal electronics and without the need to deploy additional filter equipment on the line. The present invention is a modification to existing apparatus to comply with a novel FTTP Test Algorithm for tuning and using an optical time domain reflectometer (OTDR). The present invention enables non-interruptive interrogation of optical impairments on optical transmission lines. The present invention represents a great improvement over current methods. Current methods require the feeder and/or legs of the ODN to be taken out of service for testing thus resulting in service interruption for the customer and loss of revenue for the service provider due to increased maintenance expenditures. Typically there are a number of WDM (2) combiners used to couple and decouple bidirectional traffic.

The fiber configuration for which this invention applies is a single fiber connection having feeder (4) optical loss or a length that represents the maximum sensitivity of the OTDR.

The fiber feeder (4) has loss and physical characteristics that are known.

The fiber feeder terminates on a passive splitter/coupler device (6) which has known loss characteristics and splits the incoming feeder light source into “N” separate output legs (7). (where “N” is 1 or greater) In the preferred embodiment N=32.

The opposite side from the feeder connects to optical fibers for distribution to “N” end points. (5)

The application of the method described in the present invention is specific, but not limited to the center optical filter rejection area (26) of the ONT. (5) The method for testing can be used at any frequency that does not interfere with the optical transceivers of the pass band (14,25) of the transmission system.

Transceivers for PON system applications terminate in optical band pass filters at the end of the legs. may be equipped with band splitters for WDM.

The optical line is stimulated by a Laser transceiver pair in the OTN. (3)

The optical frequency for the Laser source is chosen at a specific wavelength using the novel FTTP Test algorithm. (27) The wavelength corresponds to the center frequency of the optical rejection area (26) or “non” pass band of the filter contained at the terminal end of the optical leg.

As part of the OTN (3) there is an OTDR containing the Laser source tuned to the chosen frequency that can be modulated to provide any output pulse train frequency and pulse train pulse shape and pulse train duty cycle.

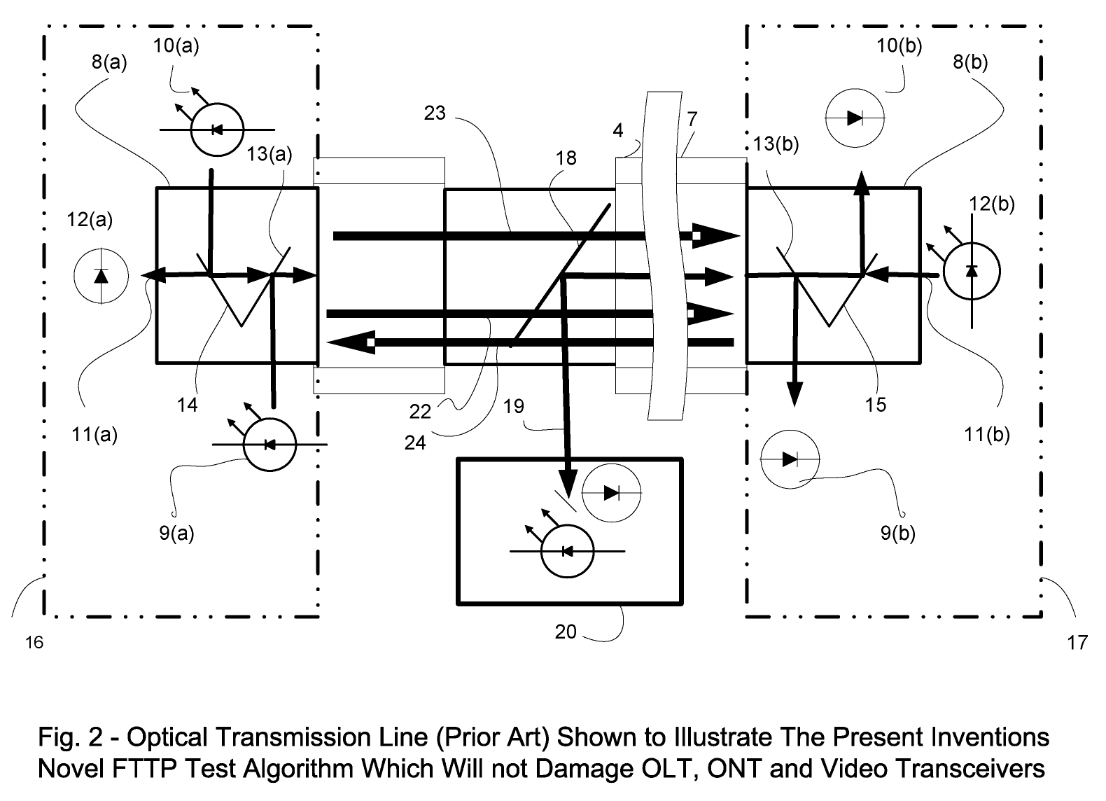

Correspondingly the first part if the exercise is to locate the best response for reflection. Referring to FIG. 2. In the FTTP system light is generated at different optical frequencies as shown in pairs, (9(a), 9(b)) and (10 (a), 10(b)) downstream (22,23) and (12(b), 12(a)) upstream. (24) In the preferred embodiment, the OTN (3) test frequency transmitted by the OTDR, (19) is introduced at the wire center on a fiber using existing optical switched access method. The optical test signal is then combined with the live traffic using a WDM device. (18) The frequency division separates the test signal from the service transmission signals. The combination travels down the line (4,7) toward the transceiver triplexer. (16,17) The transceiver triplexer will either reflect the optical test signal (Case 1) or absorb the test signal optical frequency (Case 2) by the internal filters contained in the component. (14,15) If Case 1 occurs the OTN receiver (20) will detect the reflections if Case 2 occurs no reflection will be observed at the OTN receiver (20).

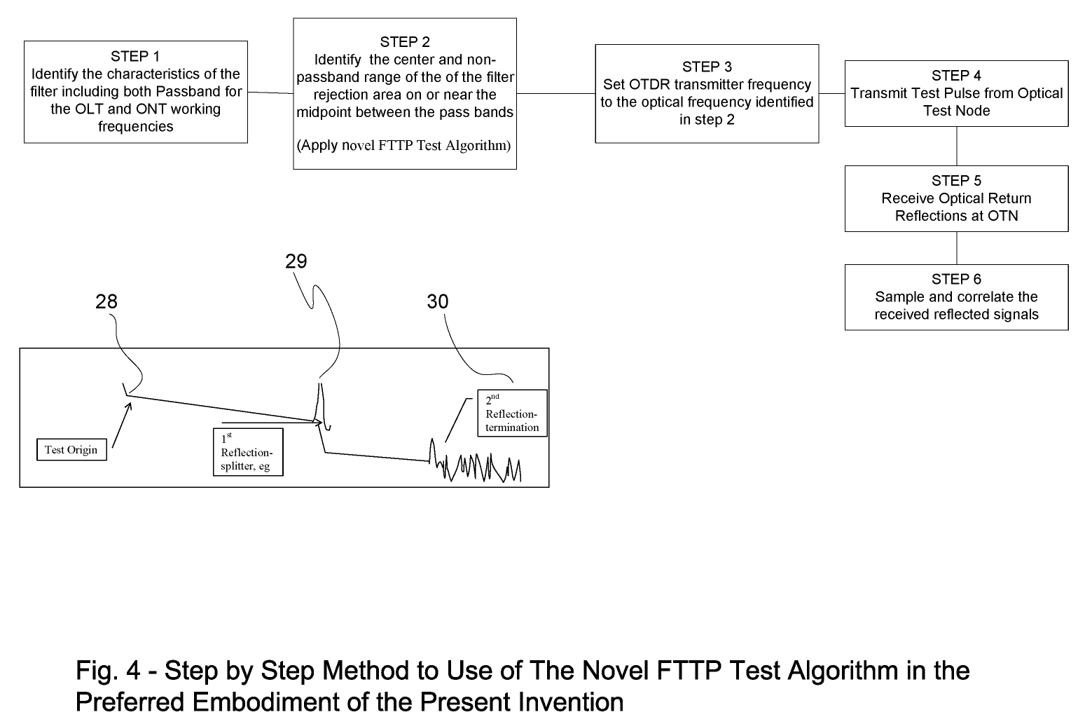

If Case 1 exists and plurality of reflections are apparent at the OTN receiver (20) advanced techniques of the present invention will be used to isolate the fault. A combination of resonance stimulation of the optical fiber and a short duty cycle will give us the ability to get enough energy in the fiber to spot problems by windowing in on expected reflections and lack of reflections to identify if the plant is responding as expected. An example of OTN OTDR information returned in the presence of working traffic and without damage to the ONT and OLT devices is presented in FIG. 4. (28,29,30)

If the plant has a reflective, such as, but not limited to, a fiber break condition that impairs light transmission a fault will be flagged located and identified using techniques familiar to those skilled in the OTDR technology.

As a result of the enhanced reflectivity of a fiber break, the OTDR will calculate the distance to fault and the OTN will report the position to the system operator.

In Case 1 where there are a plurality of return reflectance's advance post processing may be done on such flagged fault by comparison of current test results with historical results recorded prior to the fault condition occurring and thus providing assistance when locating the fiber fault as shown in FIG. 4.

The system is a novel solution to a known problem in the communications industry. No one else has developed an algorithm that targets the null spot in the filters attached to the end of the fiber. All other solutions either add cost to the fiber distribution or run the risk of damaging the sensitive transceivers present in the terminal equipment.

The light coming into the triplexer band-pass filter will reflect back toward the OLT or reflected toward an energy absorber when irradiated with the test frequency center wavelength. Thus the optical return loss is determined by the characteristics of the triplexer component filter system. In the preferred embodiment described here, it is expected that the filter employed will either reflect large amounts (Case 1) of the energy or absorb large amounts of the energy (Case 2) when illuminated with the frequency chosen using the novel FTTP Test Algorithm.

A detail description of the implementation of the preferred embodiment of the present invention is presented below.

Case 1) The pulse is reflected by the band-pass filter rejection from the triplexer transceiver is such that the return loss (27) is very low:

a. The apparatus invention uses the topology map of the optical circuit to calculate the time of flight (TOF) for the round trip pulse for each leg based on an expected reflection TOF calculated from the record of the feeder and legs. Where Cmedia represents the speed of light in the media of transmission. In this case the media would be Silica.
TOF=(Distance of feeder+Distance of leg)/Cmedia

b. Attenuation is estimated based on loss for the feeder and each leg.

c. The transmission line is stimulated with a test signal which is modulated to optimize the energy density of the reflected pulse returning to the splitter/coupler port for the specific leg in test.

d. Sweeping modulation causes pulse density to vary. At specific pulse train or sign wave frequencies each leg in turn will experience first order (2nd order, 3rd order etc.) resonance.

e. During the first order resonance (standing wave) event the radiation from the Laser will double in intensity due to the optical circuit of a specific leg hosting a standing wave.

f. The standing wave will cause an increase of energy to be present at the splitter and therefore an increase in energy at the test head receiver at the location of the test unit.

g. The resultant change in power level can be detected using enhanced correlation, windowing and OTDR technology.

h. The resonance point of each leg thus detected are input into a secondary processing stage and provides a unique signature of the fiber feeder and leg topology. This signature is the baseline from which changes are measured.

Case 2) The optical pulse is completely absorbed by the transceiver module such that the return loss in the optical range used for testing is high enough so that end reflections are not detectable from the test apparatus.

a. Choice of the center optical frequency at the point of maximum filter rejection for the triplexer of diplexer transceiver attached to the end of each leg means that the sensitive receivers will not be affected by the optical interrogation of the attached OTDR test apparatus.

b. In this case at the frequencies specified noreflections will be seen on the OTDR read out. This condition indicates a healthy network and the test can be done using the present invention, the novel FTTP Test Algorithm to choose the interrogation optical frequency and a modified OTDR, testing is accomplished without harm or interruption of service to the ONT and customer respectively.

c. Using the present invention as in Case 2 item b, if a reflection is detected the reflection or return pulse indicates a fault or open condition on the optical line.

d. Using the modified OTDR will then allow measurement to the location of the fault accurately using TOF as in Case 1.

1. Novel FTTP test apparatus for locating a fault of a transmission line in a communication system Optical Test Node (OTN) which transmits and receives a signal via a feeder at an optical frequency specified by a novel FTTP Test Algorithm. Said novel FTTP Test Algorithm being fundamental to the present invention. The communication system to be tested comprising of a OLT device connected to a feeder transmission line, a branching/coupling device which branches the feeder transmission line into a plurality of leg transmission lines each connected with the respective ONT devices. Wherein the OLT and the plurality of ONT devices perform bidirectional communication, said apparatus comprising:
an OTN containing an OTDR specially tuned to an optical frequency chosen using the novel FTTP Test Algorithm to be transmitting and receiving test signals at the optical frequency rejection area for the optical frequency splitting filter contained in the transceiver component contained in the ONT triplexer. The preferred embodiment of the present invention's novel FTTP Test Algorithm selects a frequency that is half way between the splitting filters high-pass and low-pass channels.
FTTP Test Algorithm choice of optical frequency enables transmission of certain optical pulse train test signals that stimulate the second transmission lines in such a way as to maximize the energy transferred to said second transmission lines to create a resonant condition on a unique second transmission line.
FTTP Test Algorithm means the application of composite (combined) optical pulse train test signals that result in a deterministic pattern of second transmission line stimulation in such a way as to result in a combined reflected signature in which only the desired second transmission line or group of second transmission lines are returning reflected energy to the head end optical measurement equipment.
FTTP Test Algorithm means for outputting a test signal at a specific optical frequency to the feeder using an OTDR, an optical selector switch and a band pass WDM module to stimulate the feeder (first transmission line) and detect a reflected energy of the test signal, for determining a distance to a fault point based on the time since the test signal is output until the reflected signal is detected and for comparing, for each of the legs (second transmission lines). The attenuation or reflective characteristics of both the end point components and that caused line impairments can be detected using standard industry apparatus specially tuned to said novel choice of interrogation frequency and pulse repetition rate, the signal strength and the current attenuation of the reflected signal and application of unique and novel correlation comparison of baseline test results recorded at a time during plant certification and current test results and analysis of the optical signature of the transmission line system. The hardware and software of the OTN system can determine the presence or absence and location of a fault in the feeder (transmission line 1) or the leg (transmission line 2) without interruption to traffic in the communication bands. The invention method is not limited to a specific optical frequency but can be applied at any frequency within the pass band of the optical fiber.

2. The novel FTTP Test Algorithm and apparatus according to claim 1,
wherein the first transmission line and the plurality of second transmission lines are optical transmission lines, and
wherein the first transceiver device and, the plurality of second transceiver devices, the branching/coupling device, said attenuation means and said FTTP Test Algorithm means transmit and receive optical signals through the optical transmission lines connected to said devices.

3. The novel FTTP Test Algorithm apparatus according to claim 1,
wherein said FTTP Test Algorithm means the specific attenuation condition by an optical signal at a specific wavelength which is transmitted and reflected through the optical transmission lines.

4. The novel FTTP Test Algorithm apparatus according to claim 1,
wherein said FTTP Test Algorithm specifies the attenuation condition by using a test wavelength and selected optical pulse frequency or series of wavelengths and optical pulse frequencies chosen to be precisely within the on-optically transmissive section of the band pass filter with respect to the bidirectional service transmission frequencies.

5. The novel FTTP Test Algorithm apparatus according to claim 3,
wherein said FTTP Test Algorithm means outputs an optical test signal of a wavelength differing from a wavelength of the optical signals used in the communication between the first device and the plurality of second devices.

6. The novel FTTP Test Algorithm apparatus claim 1,
wherein said attenuation or reflectance indicates the presence or absence of impairments to the optical line, for each of the second transmission lines, an operation to cause reflectance from a discontinuity in the index of refraction on the optical line for all of the second transmission lines when stimulated with said optical test signals for a predetermined period of time.

7. The novel FTTP Test Algorithm apparatus according to claim 2,
wherein said FTTP Test Algorithm means further specifies individual attenuation to be caused to the plurality of second transmission lines as the attenuation condition.

8. A method for locating a fault of a transmission line in a communication system in which a first device is connected to a branching/coupling device and thence separately to a plurality of second devices, said method comprising the steps of:
causing detection of individual attenuation to a plurality of transmission lines respectively connecting the branching/coupling device to the second devices outputting a test signal in a transmission line connecting the first device to the branching/coupling device; and
locating a fault of the second transmission lines based on a delay time the test signal returns as a reflected signal and based on attenuation of the reflected signal.

9. A method for locating a fault of a transmission line in a communication system including a first device which transmits and receives a signal via a first transmission line, a plurality of second devices and a branching/coupling device which branches the first transmission line into a plurality of second transmission lines each connected with the respective second devices, wherein the first device and the plurality of second devices perform bidirectional communication, said method comprising the steps of:
causing individual attenuation to a plurality of transmission lines respectively connecting the branching/coupling device to the second devices;
outputting a test signal in a transmission line connecting the first device to the branching/coupling device; and
locating a fault of the second transmission lines based on a delay time the test signal returns as a reflected signal and based on attenuation of the reflected signal.

10. A method for locating a fault of a transmission line in a communication system including a OLT first device which transmits and receives a signal via a first transmission line, a plurality of second devices and a branching/coupling device which branches the first transmission line into a plurality of second transmission lines each connected with the respective ONT second devices, wherein the first device and the plurality of second devices perform bidirectional communication, said test method shall stimulate a transmission line condition comprising steps of:
(a) causing individual attenuation through destructive resonance or constructive resonance to the plurality of second transmission lines either individually or in combination using the principal of superposition of stimulus pulse shapes and repetition rates;
(b) outputting a test signal to the first transmission line and detecting a reflected signal of the test signal;
(c) determining a distance to a fault point based on the time since outputting the test signal in step (b) until detecting the reflected signal in step (b); and
(d) comparing, for each of the second transmission lines, the attenuation caused in step (a) with attenuation of the reflected signal detected in step (b) and based on the comparing, determining a faulty one of the second transmission lines.
(e) comparing historical or calculated results, for each of the second transmission lines, the attenuation caused in step (b) with attenuation of the reflected signal detected in step (c) and based on the comparing, determining a faulty second transmission line.
